(19) United States
(12) Patent Application Publication
(10) Pub. No.: US 2015/0081627 A1
(43) Pub. Date: Mar. 19, 2015

(54) Managing Data Items Across Multiple Data Services

(71) Applicant: Portal Architects, Inc., Ann Arbor, MI (US)

(72) Inventors: Mark B. Brazeau, Ann Arbor, MI (US); Steven E. Woodward, Canton, MI (US)

(21) Appl. No.: 14/305,968

(22) Filed: Jun. 16, 2014

Related U.S. Application Data
(60) Provisional application No. 61/877,642, filed on Sep. 13, 2013.

(51) Int. Cl. G06F 17/30; H04L 29/08

(52) U.S. Cl. CPC G06F 17/30569; G06F 17/30575; H04L 67/10
USPC 707/610; 707/756

(57) ABSTRACT

Methods and systems for managing data items across multiple data services are disclosed. The method includes establishing a first connector with a source data service and a second connector with a destination data service. The method also includes receiving a job implicating data items that are to be transferred to the destination data service. For each item, the method includes determining whether a set of operations needs to be performed on the data item to comply with requirements of the destination data service. When a set of operations needs to be performed, the method includes instantiating an operation pipeline including one or more operators based on the set of operations. The method further includes receiving the data item via the first connector, transforming the data item to a transformed data item using the pipeline, and transmitting the transformed data item to the destination data service via the second connector.

### TECHNICAL FIELD

This disclosure relates to techniques for managing data items across multiple data services.

### BACKGROUND

Businesses and consumers alike are faced with the growing challenge of integrating often siloed sources of information; whether the information is stored files or relational data. For example, many organizations often manage multiple on-premises storage repositories such as file-shares, Enterprise Content Management (ECM) systems, email, and relational databases in addition to cloud service providers that deliver similar services and functions. These myriad systems (sometimes dozens) are often difficult to integrate together as their connectivity interfaces, communication protocols and functionality vary greatly.

### SUMMARY

One aspect of the disclosure provides a method including establishing, at a processing device, a first connector with a source data service and a second connector with a destination data service. The method also includes receiving, at the processing device, a job implicating one or more data items associated with the course data service that are to be transferred to the destination data service. For each item, the method includes determining, at the processing device, whether a set of operations needs to be performed on the data item to comply with requirements of the destination data service. When a set of operations needs to be performed on the data item, the method includes instantiating, at the processing device, an operation pipeline based on the set of operations. The operation pipeline includes one or more operators. Each operator corresponds to a respective operation in the set of operations. The method further includes receiving, at the processing device, the data item via the first connector; transforming, at the processing device, the data item to a transformed data item using the pipeline; and transmitting, at the processing device, the transformed data item to the destination data service via the second connector.

Implementations of the disclosure may include one or more of the following features. In some implementations, the method may include a set of operations that transform the data item such that the transformed data item is compatible with the destination service. Additionally or alternatively, the method may include each operator in the operation pipeline performing an operation on at least a portion of the data item.

In some implementations, the method includes determining a sequence of the operations in the set of operations. The sequence of the operations defines an order by which the operators are to operate on the data item. Additionally or alternatively, the method may include instantiating the operation pipeline by determining an operator that performs the defined operation and instantiating the operator. The input and output of each instantiated operator is based on the sequence of the operations.

The method may include the data item being streamed from the source data service as a data stream including a plurality of chunks, wherein the one or more operators operate on individual chunks of the data stream. Additionally or alternatively, the method may include the second connector streaming the transformed data item to the destination data service.

The job may include one of a synchronization job, an archiving job, a publishing job, and a copying job. In some implementations, when the job is a synchronization job, the method further includes determining, at the processing device, destination data items to transfer from the destination data service to the source data service. For each destination item, the method further includes determining, at the processing device, whether one or more operations need to be performed on the destination data item to comply with requirements of the source data service. When one or more operations need to be performed on the destination data item, the method further includes instantiating, at the processing device, an operation pipeline based on the set of operations. The operation pipeline includes one or more operators, with each operator corresponding to a respective operation in the set of operations. The method further includes receiving, at the processing device, the destination data item via the second connector; transforming, at the processing device, the destination data item to a transformed destination data item using the operation pipeline; and transmitting, at the processing device, the transformed destination data item to the source data service via the first connector.

In some implementations, each respective data item has a respective operation pipeline instantiated therefor, the respective operation pipeline having operators for transforming the respective data item and only being used to transform the respective data item into a respective transformed data item. According to some implementations, the source data service and the destination data service are independent cloud-based data storage services.

Another aspect of the disclosure provides a transfer server including a storage device storing a plurality of data service classes and operator classes. The transfer server also includes a processing device executing a transfer module. The transfer module is configured to instantiate a first connector with a source data service from one of the plurality of data service classes and instantiate a second connector with a destination data service from another one of the plurality of data service classes. The transfer module is further configured to receive a job. The job implicates one or more data items associated with the source data service that are to be transferred to the destination data service. For each data item implicated by the job, a set of operations is required to be performed thereon in order to comply with requirements of the destination data service. The transfer module further instantiates an operation pipeline based on the set of operations. The operation pipeline includes one or more operators. Each operator corresponds to a respective operation in the set of operations and being instantiated from one of the plurality of operator classes. Each operator further receives the data item via the first connector; transforms the data item to a transformed data item using the pipeline, and transmits the transformed data item to the destination data service via the second connector.

In some implementations, the set of operations may be operations that transform the data item such that the transformed data item is compatible with the destination data service. Additionally or alternatively, each operator in the operation pipeline may perform an operation on at least a portion of the data item.

In some examples, the transfer module is further configured to determine a sequence of operations in the set of operations. The sequence of the operations defines an order by which the operators are to operate on the data item. Additionally or alternatively, the transfer module may instantiate the operation pipeline by determining an operator that performs the defined operation and instantiating the operator. The input and output of each instantiated operator is based on the sequence of the operations.

In some implementations, the data item is streamed from the source data service as a data stream including a plurality of chunks. One or more operators operate on individual chunks of the data stream. Additionally or alternatively, the second connector may stream the transformed data item to the destination data service.

The job may be one of a synchronizing job, an archiving job, a publishing job, and a copying job. When the job is a synchronizing job, the transfer module is further configured to determine destination data items to transfer from the destination data service to the source data service. For each destination data item, the transfer module determines whether a set of operations needs to be performed on the destination data item to comply with requirements of the source data service. When a set of operations needs to be performed on the destination data item, the transfer module instantiates an operation pipeline based on the set of operations. The operation pipeline includes one or more operators. Each operator corresponds to a respective operation in the set of operations. The operators receive the destination data item via the second connector; transform the destination data item to a transformed destination data item using the operation pipeline; and transmit the transformed destination data item to the source data service via the first connector.

In some implementations, the transfer module may instantiate a respective operation pipeline for each respective data item. The respective operation pipeline has operators for transforming the respective data item being used to transform the respective data item into a respective transformed data item.

The details of one or more implementations of the disclosure are set forth in the accompanying drawings and the description below. Other aspects, features, and advantages will be apparent from the description and drawings, and from the claims.

Another aspect of the disclosure provides a method for performing a search across a plurality of data services. The method includes receiving, at a processing device, a search query. The method further includes, for each data service of the plurality of data services, instantiating, at the processing device, a search operator for the data service; providing, at the processing device, the search query to each search operator to obtain a converted search query; providing, at the processing device, the converted search query to the data service; receiving, at the processing device, search results from the data service; and inserting, at the processing device, the search results into a virtual folder. The search results indicate data items stored at the data service that correspond to the converted search query. Each search operator being configured to convert the search query into a format accepted by the data service. The method further includes providing, by the processing device, the virtual folder for display at a remote computing device.

In some implementations, the method further includes, for each data service, instantiating, at the processing device, a connector for communicating with the data service. The operator of the data service communicates the converted search query to the data service via the connector. According to some implementations, the search results from each respective data service are inserted into the virtual folder. The virtual folder can include one or more subfolders.

In some implementations, the method further includes receiving a job request based on the search results. The job request indicates a job implicating two or more of the plurality of data services. In these implementations, the method further includes performing the job.

### DESCRIPTION OF DRAWINGS

FIG. 1 is a schematic illustrating an example environment for transferring data items across multiple data services.

FIG. 2 is a schematic illustrating example components of a transfer server.

FIG. 3 is a flow chart illustrating an example set of operations of a method for transferring data items across multiple data services.

FIG. 4 is a flow chart illustrating an example set of operations of a method for establishing and executing an operation pipeline.

FIG. 5 is a schematic illustrating an example of a synchronization job being executed by a transfer server.

FIG. 6 is a schematic illustrating an example of a copying job being executed by a transfer server.

FIG. 7 is a schematic illustrating an example of a synchronization job being executed by a transfer server.

FIG. 8 is a schematic illustrating an example of a graphical user interface displaying a virtual folder containing search results.

FIG. 9 is a flow chart illustrating an example set of operations of a method for performing a search across multiple data services.

FIG. 10 is a flow chart illustrating an example set of operations of a method for performing a search on a connected data service.

Like reference symbols in the various drawings indicate like elements.

### DETAILED DESCRIPTION

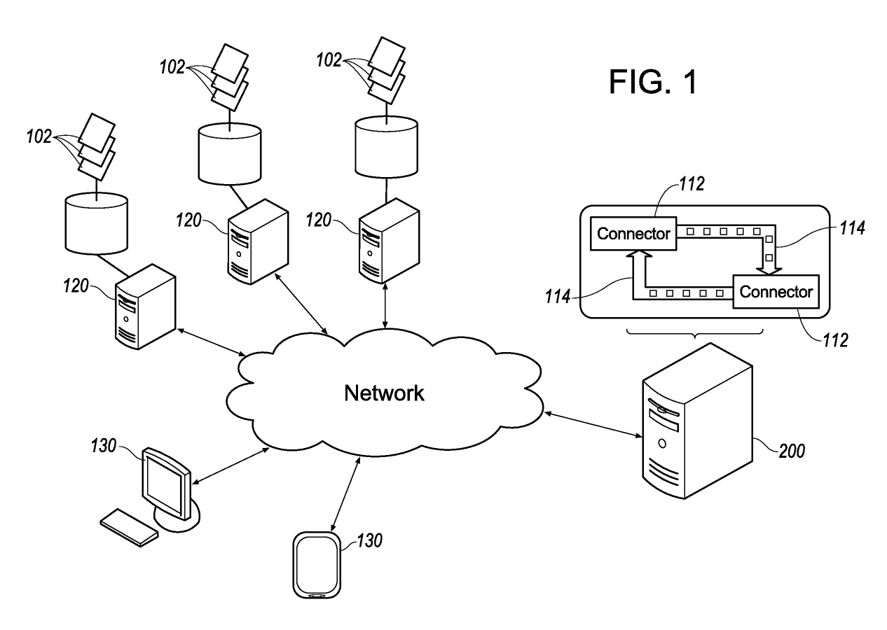

Referring to FIG. 1, a system 100 for transferring data items 102 between data services 120 is disclosed. The system 100 includes a transfer server 200 that facilitates the transfer of data items 102 between two or more data services 120. A data service 120 can be any cloud-based service or on premise service that stores data items 102. Examples of data services 120 include Huddle® enterprise services by Ninian Solutions Ltd., Dropbox® storage services by Dropbox Inc., Microsoft SharePoint® collaboration software services by Microsoft Corp., Google Drive® storage services by Google Inc., Microsoft Outlook® cloud computing software services by Microsoft Corp., and Gmail® electronic mail services by Google Inc. A data item 102 can be any type of data stored by a data service 120. Examples of data items include data files, database records, emails, Microsoft SharePoint® lists, audio files, video files, binary large objects, and other related artifacts. A data item 102 can include the content of the data item 102 and the metadata of the data item. As used herein, the term data service can include the actual service being provided and/or the servers which operate to provide the service.

A user (e.g., a network administrator) can access the transfer server 200 via a computing terminal 130 (e.g., a desktop computer 130 or a mobile computing device 130) and assign one or more jobs to the transfer server 200. A job can be a task that the transfer server 200 is configured to perform. Examples of jobs include copying data items 102 from a data service 120 to one or more other data services 120 (a “copying job”), publishing data items 102 from a data service 120 to one or more other data services 120 (a “publishing job”), archiving data items 102 from a first data service 120 at one or more other data services 120 (an “archiving job”), and synchronizing data items 102 between two or more data services 120 (a “synchronizing job”). The user can either provide an explicit instruction to the transfer server 200 to perform one or more jobs or can administer a schedule that defines when certain jobs are to be performed.

A synchronizing job can refer to the task of updating one or more data services 120 with one or more data items 102 stored at other data services 120. For example, if a first data service 120 stores data items [A, B, and C] and a second data service 120 stores data items [D, E, F], synchronizing the first and second data services 120 can include transferring [D, E, F] to the first data service 120 and transferring data items [A, B, C] to the second data service 120. In this example, each data service 120 can include data items [A, B, C, D, E, F] when the synchronization is complete. While described with respect to two data services 120, synchronization may be performed between three or more data services 120 as well.

A copying job can refer to the task of transferring one or more data items 102 from a first data service 120 to one or more other data services 120. For example, if a first data service 120 stores data items [A, B, and C] and a second data service 120 stores data items [D, E, F], copying from the first data service to the second data services 120 can include transferring [A, B, C] to the second data service 120. After copying from the first data service 120 to the second data service 120, the first data service 120 can have data items [A, B, C] stored thereon, and the second data service can have data items [A, B, C, D, E, F] stored thereon. While described with respect to two data services 120, data items may be copied to more than one data service 120.

A publishing job can refer to the task of transferring one or more data items 102 from a first data service 120 to one or more other data services 120 and purging the one or more other data services 120 of the files previously stored thereon. For example, if a first data service 120 stores data items [A, B, and C] and a second data service 120 stores data items [D, E, F], publishing from the first data service to the second data services 120 can include transferring [A, B, C] to the second data service 120 and purging [D, E, F] from the second data service. Thus, after publishing from the first data service 120 to the second data service 120, both the first data service 120 and the second data service 120 include data items [A, B, C] and neither stores [D, E, F]. While described with respect to two data services 120, data items may be published to more than one data service 120.

An archiving job can refer to the task of transferring one or more data items 102 from a first data service 120 to one or more data services 120 and purging the first data service 120 of the transferred filed. For example, if a first data service 120 stores data items [A, B, and C] and a second data service 120 stores data items [D, E, F], archiving the first data service can include transferring [A, B, C] to the second data service 120 and purging [A, B, C] from the first data service 120. The result of the foregoing archiving job is that the first data service 120 no longer stores [A, B, C], while the second data service 120 stores [A, B, C, D, E, F]. While described with respect to two data services 120, data items may be archived at more than one data service 120.

The foregoing are examples of jobs that the transfer server 200 can perform. Other jobs are contemplated and are within the scope of the disclosure.

In operation, the transfer server 200 executes a job by identifying the job and the data services 120 to which the job corresponds. The transfer server 200 creates connectors 112 corresponding to the data services 120 that are implicated by the job. A connector 112 is an interface that allows the transfer server 200 to communicate with a particular data service 120. A connector 112 can implement one or more application programming interfaces (API) used to interact with a particular data service 120. For example, if the job implicates a first data service 120 and a second data service 120, the transfer server 200 creates a first connector 112 to interface with the first data service 120 and a second connector 112 to interface with the second data service 120. In some implementations, the transfer server 200 creates a connector 112 by instantiating an instance of a connector object corresponding to a particular data service 112. The instantiated connector object 112 can implement the API used to access, communicate with, and/or command the particular data service 120.

In some implementations, the transfer server 200 is configured to interrogate a data service 120 to determine what data items 102 stored by the data service 120 are to be transferred from the data service 120. The transfer server 200 may interrogate a data service 120 by sending a request for a list of data items 102 that correspond to a particular account or entity. The request may be provided via a corresponding connector 112, which utilizes the API of the data service 120 to format the request. The data service 120 responds by providing a list of data items 102 stored by the data service 120. For each of the data items 102 to be transferred, the transfer server 200 also determines attributes of the data item 102. Attributes of a data item 102 can include a name of the data item, a size of the data item, a data type or format of the data item, a time stamp of the data item, whether the data item is compressed, etc. The attributes of a data item 102 along with the requirements of the data service 120 to which the data item 102 is being transferred dictate whether the data item requires transformation.

Each data service 120 may have different requirements. For example, different data services 120 may have different naming conventions of data items, accepted formats of data items, size limitations of data items, etc. The transfer server 200 can also determine the requirements for the data services 120 implicated by the job. Based on the attributes of a particular data item 102 to be transferred and the requirements of the destination data service 120 to which the particular data item 102 is being transferred, the transfer server 200 can determine whether one or more operations need to be performed on the particular data item 102. For example, a destination data service 120 may not accept data items having titles with spaces. If a data item 102 has a space in its name, then the transfer server 200 must rename the data item. Thus, a determined operation may be a “remove space from name” operation, whereby the transfer server removes the spaces from the name. In another example, a data item 102 to be transferred may be three gigabytes (3 GB) and the destination data service 120 may have a two gigabyte (2 GB) size limitation on data items 102. In this example, the determined operation may be a compression operation, whereby the transfer server 200 compresses the data item 102 to an adequate size.

In some implementations, the transfer server 200 instantiates an operation pipeline 114 for a data item 102 being transferred from a first (source) data service 120 to a second (destination) data service 120. An operation pipeline 114 includes one or more operators 116. An operator 116 can be an object that performs a specific operation on at least a portion of a data item 102. In some implementations, the operators 116 in the pipeline are sequenced in a particular order, such that some operations are performed after other operations, while some operations may be performed simultaneously. In some implementations, the operation pipeline 114 is specific to the data item 102/destination data service 120 combination. Thus, if multiple data items 102 are being transferred to a destination data service 120 from a source data service 120, then the transfer server 200 may instantiate multiple pipelines. In other implementations, the transfer server 200 instantiates a single pipeline that includes all of the required operators 116, such that each data item 102 is passed through the operation pipeline 114.

In some implementations, the transfer server 200 receives a data item 102 as a stream from a source service 120. In these implementations, the data item 102 is delivered as a series of chunks. The transfer server 200 feeds the chunks of the data item 102 into the operation pipeline 114 that corresponds to the data item 102. As the operators 116 of the operation pipeline 114 transforms the chunks of the data item 102 are transformed, the transformed chunks are streamed to the destination data service 120 via its corresponding connector 112.

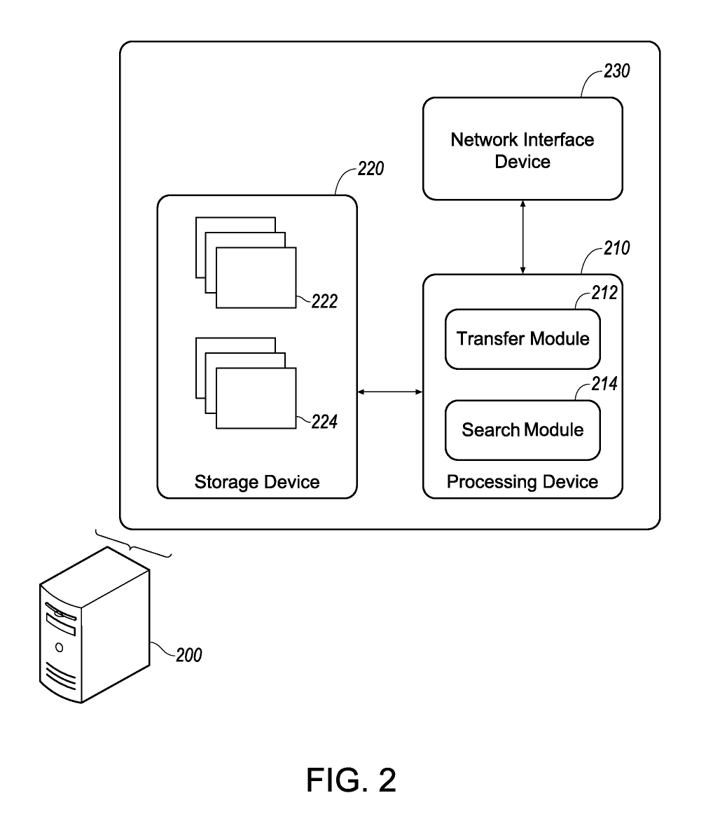

FIG. 2 illustrates an example implementation of a transfer server 200. In the example implementation, the transfer server 200 includes a processing device 210, a storage device 220, and a network interface device 230.

The processing device 210 includes one or more processors and one or more non-transitory computer-readable mediums (e.g., read only memory and/or random access memory) that store machine-readable instructions that are executed by the one or more processors. In implementations where the processing device 210 includes two or more processors, the processors can execute in a distributed or individual manner. The processing device 210 can execute a transfer module 212, which controls the transfer of data items 102 from a first data service 120 to one or more other data services 120. The processing device 210 can also execute a search module 214, which allows a user to search across multiple data services 120. The processing device 210 may execute other modules not shown.

The storage device 220 can include one or more non-transitory storage mediums. Examples of storage mediums can include, but are not limited to, hard disk drives, optical disk drives, and flash memory. In some implementations, the storage device 220 stores data service classes 222 and operator classes 224. The storage device 220 can store additional information not shown. For example, the storage device 220 can store configuration data and audit data.

The network interface device 230 includes one or more suitable devices configured to send and receive data via a network 140. The network interface device 230 can perform wireless or wired communication using any known or later developed communication standards.

The transfer module 212 is configured to receive requests to perform a job and to execute the job. The transfer module 212 can receive a request to perform a job from a user, such as a network administrator via a computing device 130 (FIG. 1). Additionally or alternatively, a user can define a schedule, such that the requests are provided to the transfer module 212 based on the contents of the schedule. The transfer module 212 may be configured to receive requests to perform a job in other manners.

In response to receiving a request to perform a job, the transfer module 212 determines the data services 120 (FIG. 1) that are implicated by the job. In some implementations, the transfer module 212 instantiates a connector for each data service 120 implicated in the request. For each data service 120, the transfer module 212 can instantiate a data service class 222 corresponding to the data service 120. The instantiated class/object is the connector 112 between the transfer module 212 and the data service 120. Further, the instantiated connector 112 implements the API for communicating with the data service 120. Thus, the transfer module 112 uses a single set of commands and the instantiated connector 112 translates the commands in accordance with the API of its corresponding data service 120. In this way, the transfer module 212 is platform agnostic. Further, the connector 112 provides for a discoverable framework, such that each connector 112 indicates to the transfer module 212 the features and processing types that the connected data service supports.

The transfer module 212 also determines which data services 120 are source data services 120 and which data services 120 are destination data services 120. For purposes of explanation, data items 102 are transferred from source data services 120 and transferred to destination data services 120. In some situations a data service 120 can be both a source data service and a destination data service (e.g., during a synchronization job). The transfer module 212 can determine the source and destination data services 120 based on the job being performed. For instance, if the job is to copy from a first data service 120 to a second data service 120, then the first data service 120 is the source and the second data service 120 is the destination. If the job is to synchronize between the first and second data service 120, then both data services 120 are sources and both are destinations. If the job is to publish from the second data service 120 to the first data service 120 and a third data service 120, then the second data service 120 is the source and the first and third data services 120 are the destinations.

The transfer module 212 determines which data items 120 are to be transferred. For each source data service 120 the transfer module 212 can determine the data items 120 stored at the source data service 120. The transfer module 212 can interrogate the source data service 120 for its stored data items 102 via the connector 112 to the data service 120. The transfer module 212 can also obtain the attributes of each data item 102 that is to be transferred during or in response to the interrogation.

For each data item 102 that is to be transferred to a destination data service 120 (or multiple destination data services 120), the transfer module 212 determines whether one or more operations need to be performed on the data item 102. The transfer module 212 can make this determination based on the attributes of the data item 102 and the requirements of the destination data service 120. The requirements of the destination data service 120 may be obtained from the instantiated connector 112 to the destination data service 120.

If one or more operations need to be performed on a data item 102, the transfer module 212 instantiates an operation pipeline 114 for the data item 102. In some implementations, the transfer module 212 identifies which particular operations to perform on the data item 102 based on a predetermined rule set. For example, a rule may be: if the data item 102 has a size greater than the upper size limit of the destination data service 120 then perform a data compression operation on the data item 102. In another example, a rule may be: if the data item 102 is in a .doc format and the destination data service 120 only receives .PDF files, then perform a document-to-PDF operation. Any suitable rules may be implemented and the specifics of the rules depend on the data services 120.

Each recognized operation has one or more corresponding operator classes 224. An operator class 224, once instantiated, performs its corresponding operation on a data item 102. Each operator class 224 can be written to receive at least a portion of a data item 102 as input and to output a portion of the data item 102 (which is likely a transformed version of the input portion of the data item 102). Operator classes 224 can be added to the storage device 220 as needed. For example, if a new data service 120 is added that requires data items 102 to be in a new type of format, one or more operator classes 224 for converting from previously known formats to the new type of format can be added to the storage device 220. The operator classes 224 can be implemented for specific data services 120 or can be platform independent. In the former scenario, an operator class 224 can be specifically implemented for the specific data services 120. In the latter scenario, the operator class 224 can be implemented such that it can be used when transferring data items 102 to a variety of different data services 120. For instance, a compression operator 116 can be a platform independent operator 116. The operator classes 224 can be implemented to operate on the actual content of a data item 102 and/or the metadata of the data item 102. For example, an operator class 224 can be written so the operator 116 reformats metadata for a particular data service 120 or changes the name of the data item 102 so that it conforms to the requirements of the data service 120.

Once the transfer module 212 has determined which particular operations are to be performed on a data item 102, the transfer module 212 can determine a sequence of the operations. The sequence of the operations can be determined according to a predetermined rule set. Furthermore, the sequence does not need to be sequential. Put another way, some operations can be performed in parallel. For instance, operations that transform metadata and operations that transform content may be performed in parallel.

The transfer module 212 instantiates an operation pipeline 114 by feeding the output of an instantiated operator 116 to the input of the next sequential operator 116 (or operators). The transfer module 212 can also dynamically include any other parameters into the input of an operator 116. For instance, the transfer module 212 can include the output of a previous operator 116 and an output size into a compression operator 116.

Once the transfer module 212 has instantiated an operation pipeline for a data item 102, the transfer module 212 can begin executing the portion of the job corresponding to the data item 102. In some implementations the transfer module 212 can request a stream of the data item 102 from a data service 120 via its corresponding connector 112. The transfer module 212 can receive the individual chunks of the data item 102 and can begin executing the pipeline by feeding the received chunks of the data item 102 to the first operator. The transfer module 212 can do this for each instantiated operation pipeline 114.

If a data item 102 does not require any operations to be performed thereon, the transfer module 212 can simply stream, or otherwise transfer, the data item 102 from the source data service 120 to the destination data service 120.

After all of the data items 102 have been transferred to their respective destination data services 120, the transfer module 212 completes the requested job. For example, if the requested job is an archiving job, the transfer module 212 can send a request to purge the source of the transferred data items 102. The transfer module 212 may also perform some of these steps during or before the transfer of the data items. For instance, if the requested job is a publishing job, the transfer module 212 may instruct the destination data services 120 to purge one or more data items 102.

The transfer module 212 may be configured to perform other functions. For example, the transfer module 212 may be configured to perform conflict resolution when two or more similar data items 102 are stored at two or more data services 120. In these implementations, the transfer module 212 can implement any conflict resolution strategy (e.g., keep newest data item 102, keep oldest data item 102, etc.).

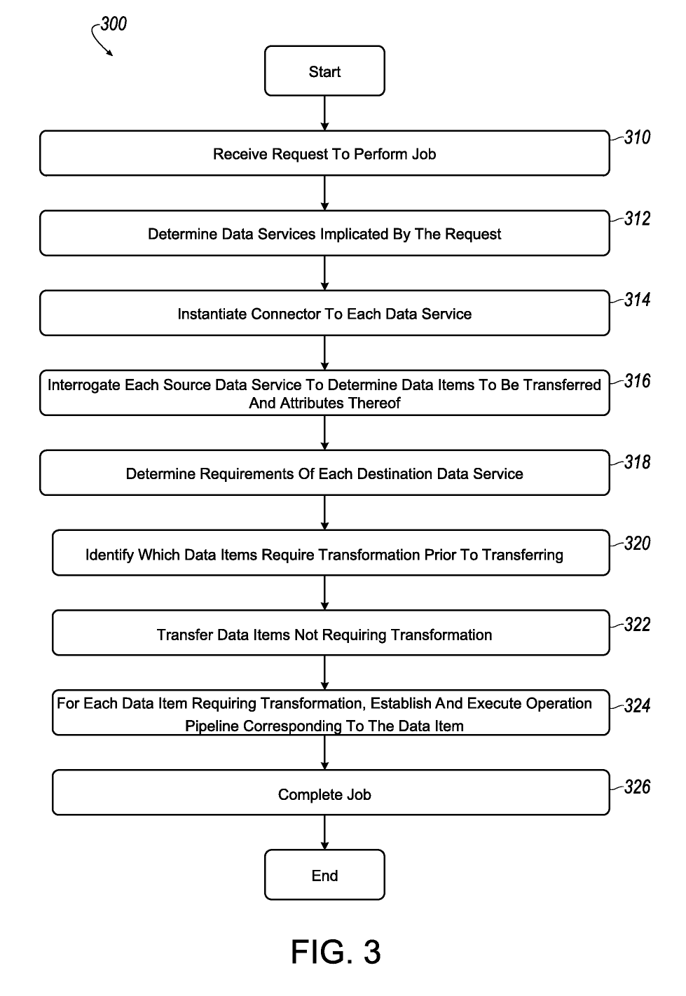

Referring now to FIG. 3, an example set of operations for a method 300 for executing a requested job is illustrated. For purposes of explanation, the method 300 is explained as being executed by the transfer module 212. The method 300, however, may be performed by other components as well.

At operation 310, the transfer module 212 receives a request to perform a job. As previously discussed, the request may be received from a computing device 130 associated with a user and/or as part of a schedule. The request may indicate the job to be performed, the data services 120 that are involved in the job, and entity information. The entity information can identify an entity to which the data items 102 correspond. An example of entity information can be an account name and a password.

At operation 312, the transfer module 212 determines the data services 120 implicated by the request. The transfer module 212 can identify data services 120 that will be acting as source data services 120 and those that will be acting as destination data services 120. As previously mentioned, a data service 120 can act exclusively as a source or destination (e.g., during a copying, publishing, or archiving job) or can act as both (e.g., during a synchronizing job).

At operation 314, the transfer module 212 instantiates connectors 112 to each of the implicated data services 120. In some implementations, the transfer module 212 retrieves data service classes 222 corresponding to each of the implicated data services 120. The transfer module 212 instantiates each retrieved data service class 222, thereby creating connectors 112 to the data services 120.

At operation 316, the transfer module 212 interrogates each source data service 120 to identify the data items 102 that are to be transferred. The transfer module 212 can interrogate a data service 102 via a corresponding connector 112 and can provide the entity information to the data service 120. In response, the data service 120 can provide a list of data items 102 and their corresponding attributes to the transfer module 212.

At operation 318, the transfer module 212 determines the requirements of each destination data service 120. In some implementations, the data service classes 222 can include a rule set that identifies the requirements of the corresponding data service 120. In these implementations, the transfer module 212 obtains the requirements of the destination data services 120 from their respective classes/objects.

At operation 320, the transfer module 212 identifies data items 102 that are to be transferred that require transformation before they can be transferred to their respective destination data service 120. The transfer module 212 can compare the attributes of each data item 102 to the rule set of its eventual destination data service 120. If a data item 102 requires transformation, then the data item 102 is labeled as such. In some scenarios, a data item 102 may be transferred to more than one destination data service 120. In such scenarios, the attributes of the data item 102 are analyzed with respect to each of the destination data services 120. For example, if a data item 102 is being published or copied to three destination services, then the transfer module 212 compares the attributes of the data item 102 to each rule set of the three destination data services 120. Thus, there may be situations where a data item 102 must be transformed to be transferred to one or more destination data services 120 but does not require transformation to be transferred to other destination data services 120.

At operation 322, the transfer module 212 transfers the data items 120 that do not require transformation to the destination data service or services 120. The transfer module 212 can request each of these data items 102 from its respective source data service 120. The transfer module 212 receives the requested data items 102 via a corresponding connector 112 and transmits each data item 102 to its corresponding destination data service or services 120.

At operation 324, the transfer module 212 establishes and executes an operation pipeline 114 for each data item 102 requiring transformation. If a data item 102 is being transferred to multiple destination data services 120 and requires transformation for transfer to two or more of the destination data services 120, then the transfer module 212 establishes operation pipelines 114 corresponding to each of the two or more destination data services 120.

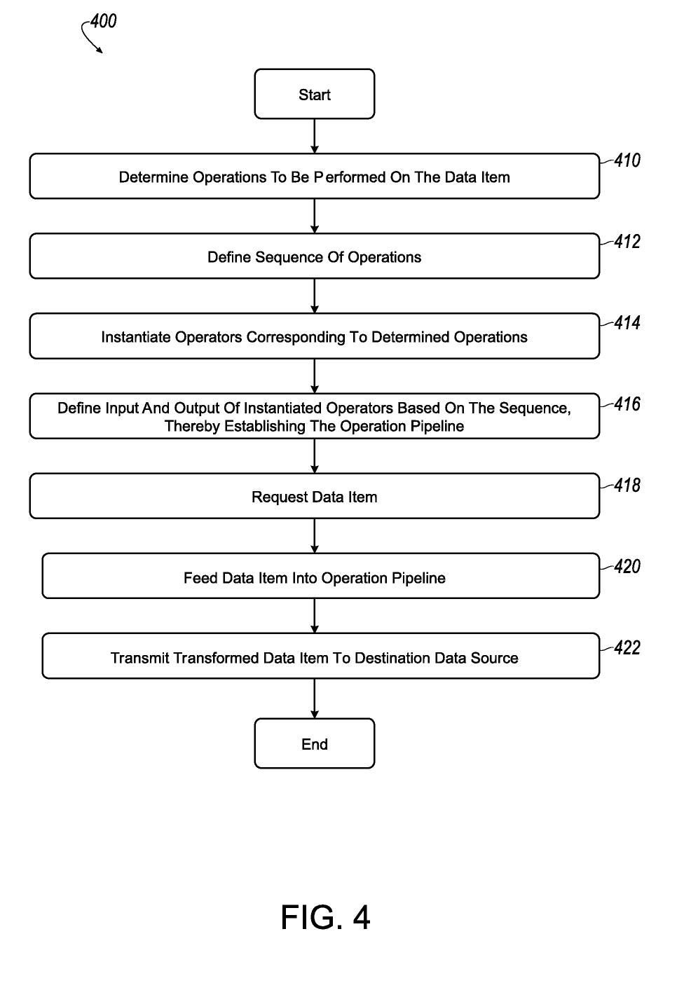

FIG. 4 illustrates an example set of operations of a method 400 for establishing and executing an operation pipeline 114. The method 400 may be executed for each data item 102/destination data service 120 combination.

At operation 410, the transfer module 112 determines which operations are to be performed on the data item 102. In some implementations, the transfer module 212 makes this determination based on the attributes of the data item 102, the requirements of the destination data service 120, and a rule set corresponding to the destination data service 120.

At operation 412, the transfer module 112 can determine a sequence of the operations to be performed on the data item 102. The order of operations may be determined on a predetermined rule set. For example, one rule may divide metadata operations and content operations into two parallel sequences. Furthermore, more expensive operations (e.g., compression) may be performed before less expensive operations (e.g., filename changes).

At operation 414, the transfer module 212 instantiates operators 116 corresponding to the determined operations. The transfer module 212 can retrieve the operator classes 224 of the corresponding operations from the storage device 220 and can instantiate each of the retrieved operator classes 224.

At operation 416, the transfer module 212 defines input and output of the instantiated operators 116 based on the sequence. The transfer module 212 can arrange the operators 116 according to the sequence by daisy chaining the outputs of operators 116 into the input of the following operator 116. In this way, the transfer module 212 establishes the operation pipeline 114 for the data item 102.

At operation 418, the transfer module 212 requests the data item 102 from the source data service 120. The transfer module 212 can transmit the request via a corresponding connector 112. In some implementations, the source data service 120 responds by transmitting the data item 102 to the transfer module 212 via the connector 112. In some implementations, the source data service 120 streams the data item 102 as a series of chunks.

At operation 420, the transfer module feeds the data item 102 into the operation pipeline 114. The transfer module 212 receives individual chunks and inputs the individual chunks to the first operator 116 of the pipeline 114. As each operator 116 executes the operation on a chunk of the data item 102, the output of the executed operator 116 feeds into a subsequent operator 116 (or operators if the pipeline 114 forks). After each chunk of the data item 102 is passed through the operation pipeline 114, the chunk exits the operation pipeline 114 as a transformed chunk. At operation 422, the transfer module 212 transmits the transformed data item 102 to the destination data service 120. In implementations where the data item 102 is streamed, the transfer module 212 can transmit each transformed data chunk to the destination data service 120 as the transformed data chunks are output by the operation pipeline 114.

Referring back to FIG. 3, at operation 312, the transfer module 212 completes the requested job. Depending on the job, the transfer module 212 may have to purge data items 102 from the source data service 120 (e.g., during an archiving job) or from the destination data service 120 (e.g., prior to performing a publishing job). Further, the transfer module 212 can deconstruct and/or deallocate any instantiated connectors 112 and operators 116 upon completion of the job.

The methods of FIGS. 3 and 4 are provided for example only. The methods are not limited to the order of operations depicted in FIGS. 3 and 4. Variations of the methods are within the scope of the disclosure.

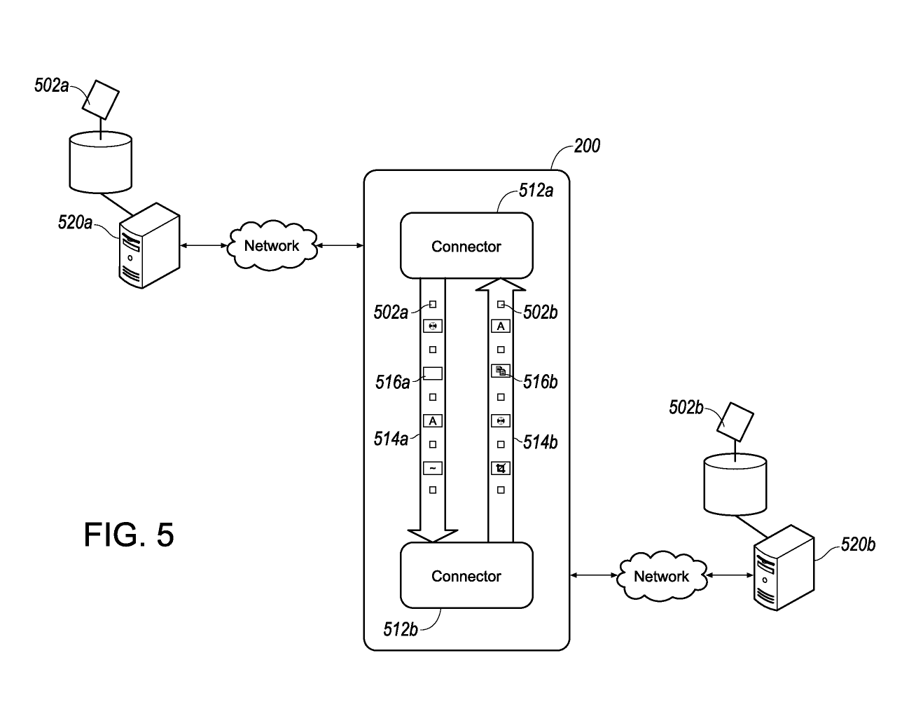

FIGS. 5-7 are schematics illustrating examples of jobs being performed. In FIG. 5, the requested job is a synchronizing job between a first data service 520a and a second data service 520b. As this is a synchronizing job, the transfer server 200 is facilitating the transfer of a data item 502a from the first data service 520a to the second data service 520b and a second data item 502b from the second data service 520b to the first data service 520a. As shown, the transfer server 200 has instantiated a first connector 112a and a second connector 112b. The first connector 112a is an interface between the transfer server 200 and the first data service 520a. The second connector 112b is an interface between the transfer server 200 and the second data service 520b. The transfer server 200 has also established a first operation pipeline 514a for transforming a first data item 502a and a second operation pipeline 514b for transforming a second data item 502b. In operation, the transfer server 200 sends requests for the data items 502a and 502b to the first data service 520a and second data service 520b via the first connector 512a and the second connector 512b, respectively.

In the illustrated example, the first data item 502a is streamed in a series of chunks, which are operated on by a plurality of operators 516a. Similarly, the second data item 502b is streamed in a series of chunks, which are operated on by a plurality of operators 516b. The transformed chunks of the first data item 502a are transmitted to the second data service 520b and the transformed chunks of the second data item 502b are transmitted to the first data service 520a.

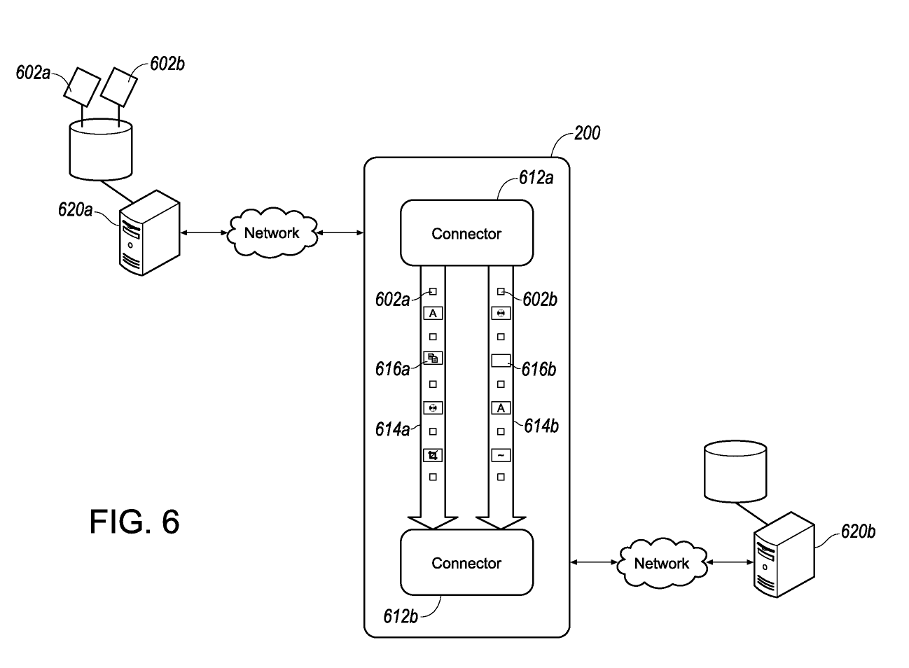

In FIG. 6, the requested job is a copying job from a first data service 620a to a second data service 620b. In this example, a transfer server 200 is facilitating the transfer of two data items 602a and 602b from the first data service 620a to the second data service 620b. Thus, the transfer server 200 has established two operation pipelines 614a and 614b that receive respective first and second data items 602a and 602b via the first connector 612a. The first operation pipeline 614a performs two operations of the first data item 602a and outputs the transformed data item 602a to the second connector 612b. The second operation pipeline 614b performs four operations on the second data item 602b and outputs the transformed data item 602b to the second connector 612b. The second connector 612b transfers the transformed data items 602a and 602b to the second data service 620b. In this way, the data items 602a and 602b have been copied to the second data service 620b.

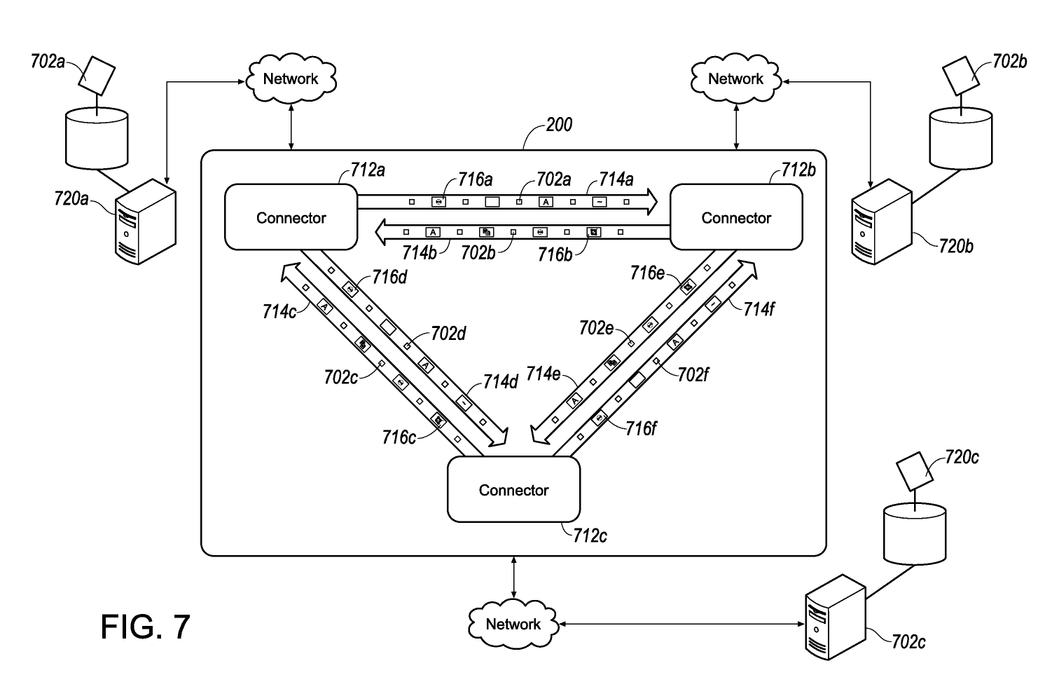

In FIG. 7, the requested job is a synchronization job between first, second, and third data services 720a, 720b, and 720c. In this example, the first data service 720a stores a first data item 702a, the second data service 720b stores a second data item 702b, and the third data service 720c stores a third data item 702c. Thus, the transfer server 200 establishes six operation pipelines 714 to facilitate the synchronization of three data items 702 across three data services 720. A first operation pipeline 714a includes a plurality of operators 716a for transforming the first data item 702a to comply with the requirements of the second data service 720b. A second operation pipeline 714b includes a plurality of operators 716b for transforming the second data item 702b to comply with the requirements of the first data service 720a. A third operation pipeline 714c includes a plurality of operators 716c for transforming the third data item 702c to comply with the requirements of the first data service 720a. A fourth operation pipeline 714d includes a plurality of operators 714d for transforming the first data item 702a to comply with the requirements of the third data service 720c. A fifth operation pipeline 714e includes a plurality of operators 716e for transforming the second data item 702b to comply with the requirements of the third data service 720c. A sixth operation pipeline 714f includes a plurality of operators 716e for transforming the third data item 702c to comply with the requirements of the second data service 720b. In this way, when each operation pipeline has been executed, each of the data services 720 will include copies of the first, second, and third data items 702a, 702b, and 702c. Further, each of the data items 702 will be formatted and compliant for the data service 720 on which it is stored.

The examples of FIGS. 5-7 are provided for example only. Much more complex scenarios are contemplated, where hundreds of operations pipelines may be established for a single job and each pipeline may have one or more forks.

Referring back to FIG. 2, the search module 214 is configured to execute searches across multiple data services 120. The search module 214 receives a search query and provides a set of zero or more results that respectively indicate data items corresponding to the search results. A user can define a search against one or more of the data services 120 using potentially complex expressions. The searches can be related to the actual content of the data items 102 or the metadata thereof. In some implementations, a search is a potential operation that can be used as the source of an operation pipeline during a synchronization operation to enable advanced business scenarios.

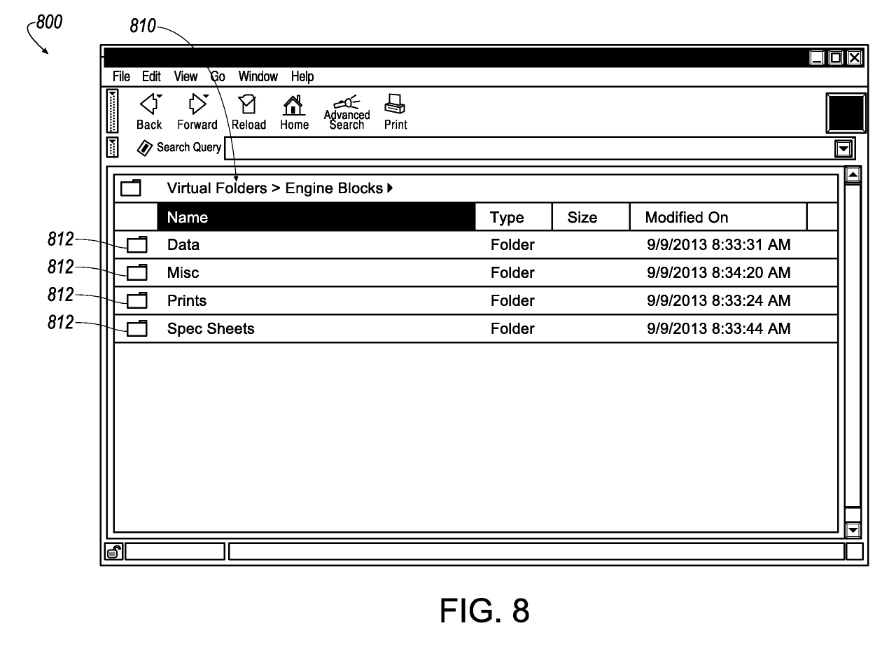

In some implementations, the user (e.g., an administrator) can define a virtual folder, such that the search results appear to the user in the virtual folder, regardless of the data service 120 that stores the data items. In this way, the search results are presented in a service-independent manner. FIG. 8 illustrates an example screen shot 800 of a virtual folder 810. In the illustrated example, a user is searching for content it has on a Microsoft SharePoint® repository. The business process of the user is enhanced when the user can view content by a product line, and also grouped into categories by content types. The user has specified that these groupings are displayed as subfolders 812 under the root of the virtual folder 810. The user can define a query against one or more Microsoft SharePoint® systems. For example in pseudo-SQL, the user can provide the following search query: “Select from SharePoint all documents where Product Line=‘Engine Blocks’ group by Content Type.” The search module 212 can present the example virtual folder 810 as the example below FIG. 1. Additional platforms can be added to the virtual folder. Folders that support metadata can create their own respective virtual subfolders for Content Type or Product Line. If platforms that do not support metadata are added to the virtual folder, their content may be shown in an “unfiled” subfolder. The search module 214 can expose virtual folders 810 via its API for others to consume and display as desired.

A user can utilize the virtual folder 810 to initiate a job. For example, the user can provide a job to synchronize the search results across the available data services 120 or to copy the search results to a particular destination data service 120. In this way, the search module 214 can instruct the transfer module 212 to perform the requested job only for the data items indicated in the search results. The search module 214 can provide the job to be performed and the search results. In some implementations, the search results indicate the source data services 120 that respectively store the indicated data items 102. Depending on the type of job (e.g., copy), the search module 212 may further provide an indicator of the destination data service 120. The transfer module 212 can execute the job in the manner described above, but can use the search results as the list of data items to be transferred.

The search module 214 can assist in tasks like e-discovery, automated content publishing, and basic content workflows. Data items 102 across multiple data services 120 can be searched for and the search results can all be displayed in the virtual folder 800.

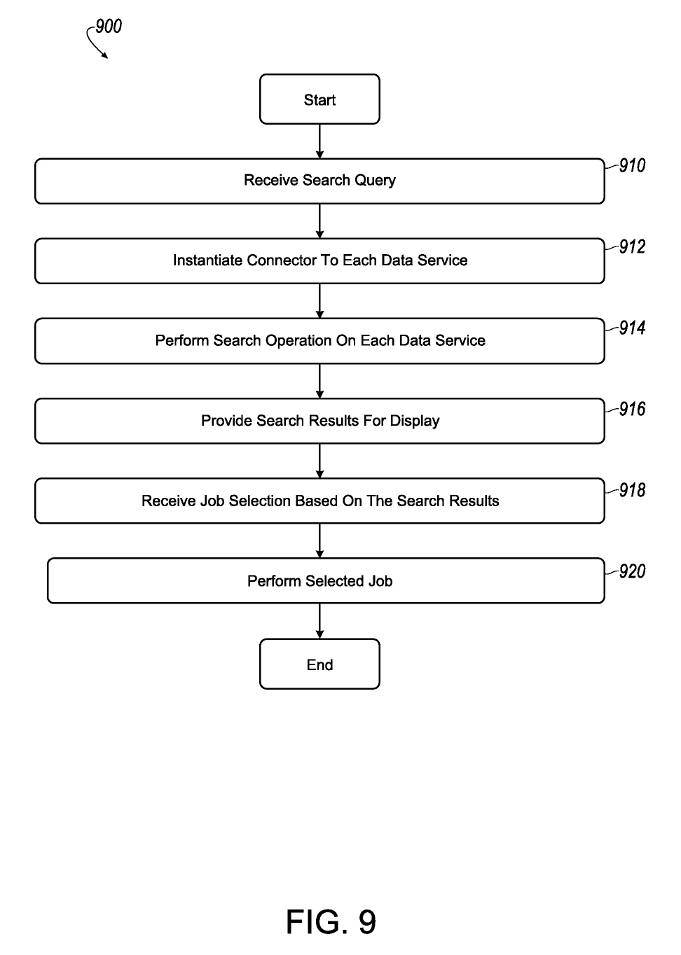

Referring now to FIG. 9, an example set of operations for a method 900 for performing a search. For purposes of explanation, the method 900 is explained as being executed by the components of the transfer server 200.

At operation 910, the search module 214 receives a search query from a computing device 130 of a user. The computing device 130 display a suitable graphical user interface (GUI) that allows the user to enter search queries. The search query can be a search for specific instances of text (i.e., a textual query) and/or for particular features of a data item. In a first example, the search query may be for any data items containing the term “invoice.” In another example, the search query may be for any data items authored or opened by “John Doe.” The search queries may be more complex. In a third example, the search query may be for any data items containing the term “invoice,” authored or opened by “John Doe,” on Jul. 10, 2013. The search query can further contain a virtual folder (and possibly subfolder) in which the search results are to be displayed. In some implementations, the user can further identify which particular data services 120 are to be searched.

At operation 912, the search module 214 instantiates connections to each of the data services 120 that the user has access to or that were implicated in the search query. The search module 214 retrieves a data service classes 222 corresponding to each of the implicated data services 120. The transfer module 212 instantiates each retrieved data service class 222, thereby creating connectors 112 to the data services 120.

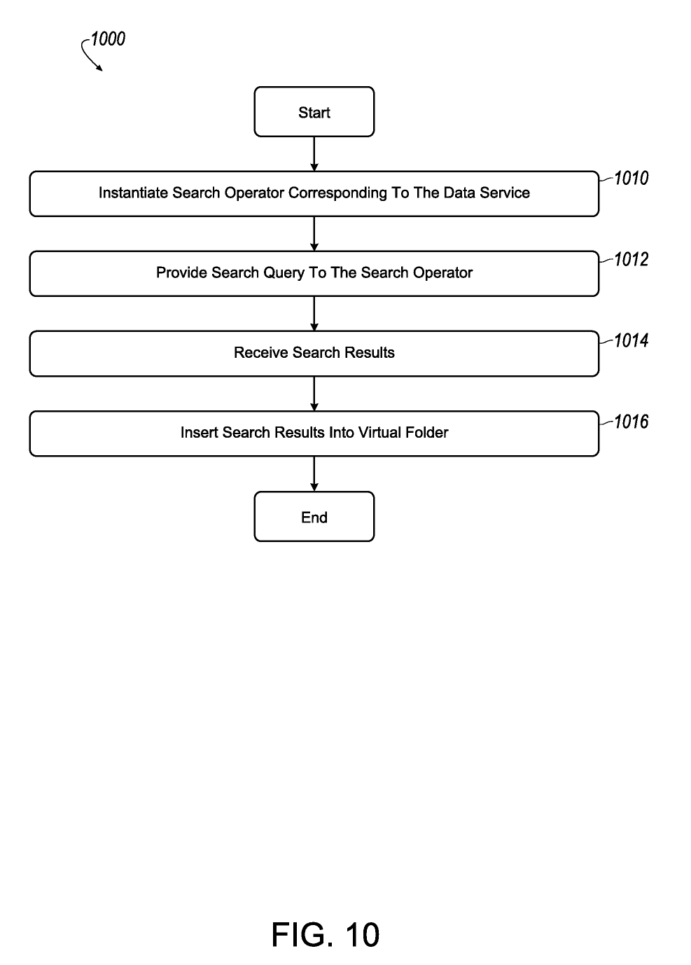

At operation 914, the search module 214 can perform searches on each connected data service 120. FIG. 10 illustrates an example set of operations for a method 1000 for performing a search on a respective connected data service. The method 1000 may be executed for each connected data service.

At operation 1010, the search module 214 instantiates a search operator corresponding to the data service 120 that is to be searched. The search module 214 can retrieve a search operator class 224 corresponding to the data service 120 from the storage device 220. The search module 214 can then instantiate a search operator based on the search operator class 224. The search operator is configured to implement an API of the data service 120. In particular, the search operator converts search queries from a format of the transfer server 200 to a format of the data service 120. The search operator can be configured to access a lookup table or to utilize a template for converting the search queries.

At operation 1012, the search module 214 provides the search query to the search operator. The search operator converts the provided search query into the format of the data service 120 according to the API of the data service 120. The search operator can output the converted search query to the connector 112 of the data service 120, which in turn provides the converted search query to the data service 120.

At operation 1014, the search module 214 receives the search results of the particular data service 120. The search results can be received via the connector 112 of the data service 130. At operation 1016, the search module 214 inserts indicators of the data items 102 identified in the search results into the virtual folder 810. As the method 1000 of FIG. 10 is performed for multiple data services 120, the virtual folder 810 may contain data items 102 from different data services but the search results will appear in a single folder (but possibly in multiple subfolders).

Referring back to FIG. 9, at operation 916, the search module 214 can provide the search results for display at the computing device 130. The search module 214 can transmit the virtual folder 810 and its contents to the requesting device 130. The requesting device 130 can in turn display the search results in a GUI.

In some implementations, the user can initiate subsequent jobs based on the search results. In these implementations, the search module 212 can receive a job selection, as shown at operation 918. In these implementations, the job selection can include the type of job (e.g., synchronizing job or copying job) and the data items 102 that are to be transferred. At operation 920, the transfer module 212 performs the selected job. The transfer module 212 can perform the job in the manner described above with respect to FIGS. 3-7.

The method of FIGS. 9 and 10 are provided for example only. The methods are not limited to the order of operations depicted in FIGS. 9 and 10. Variations of the methods are within the scope of the disclosure.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
establishing, at a processing device, a first connector with a source data service and a second connector with a destination data service;
receiving, at the processing device, a job, the job implicating one or more data items associated with the source data service that are to be transferred to the destination data service;
for each data item:
determining, at the processing device, whether a set of operations need to be performed on the data item to comply with requirements of the destination data service;
when a set of operations need to be performed on the data item:
instantiating, at the processing device, an operation pipeline based on the set of operations, the operation pipeline including one or more operators, each operator corresponding to a respective operation in the set of operations;
receiving, at the processing device, the data item via the first connector;
transforming, at the processing device, the data item to a transformed data item using the pipeline; and
transmitting, at the processing device, the transformed data item to the destination data service via the second connector.

2. The method of claim 1, wherein the set of operations are operations that transform the data item such that the transformed data item is compatible with the destination data service.

3. The method of claim 2, wherein each operator in the operation pipeline performs an operation on at least a portion of the data item.

4. The method of claim 1, wherein determining a set of operations includes determining a sequence of the operations in the set of operations, the sequence of the operations defining an order by which the operators are to operate on the data item.

5. The method of claim 4, wherein instantiating the operation pipeline includes:
for each operation defined in the set of operations:
determining, at the processing device, an operator that performs the defined operation;
instantiating, at the processing device, the operator;
wherein input and output of each instantiated operator is based on the sequence of the operations.

6. The method of claim 1, wherein the data item is streamed from the source data service as a data stream comprised of a plurality of chunks, wherein the one or more operators operate on individual chunks of the data stream.

7. The method of claim 6, wherein the second connector streams the transformed data item to the destination data service.

8. The method of claim 7, wherein the job is one of a synchronization job, an archiving job, a publishing job, and a copying job.

9. The method of claim 8, wherein when the job is a synchronization job, the method further comprises:
determining, at the processing device, destination data items to transfer from the destination data service to the source data service;
for each destination data item:
determining, at the processing device, whether one or more operations need to be performed on the destination data item to comply with requirements of the source data service;
when one or more operations need to be performed on the destination data item:
instantiating, at the processing device, an operation pipeline based on the set of operations, the operation pipeline including one or more operators, each operator corresponding to a respective operation in the set of operations;
receiving, at the processing device, the destination data item via the second connector;
transforming, at the processing device, the destination data item to a transformed destination data item using the operation pipeline; and
transmitting, at the processing device, the transformed destination data item to the source data service via the first connector.

10. The method of claim 1, wherein each respective data item has a respective operation pipeline instantiated therefor, the respective operation pipeline having operators for transforming the respective data item and only being used to transform the respective data item into a respective transformed data item.

11. The method of claim 1, wherein the source data service and the destination data service are independent cloud-based data storage services.

12. A transfer server comprising:
a storage device storing a plurality of data service classes and operator classes;
a processing device executing a transfer module, the transfer module being configured to:
instantiate a first connector with a source data service from one of the plurality of data service classes;
instantiate a second connector with a destination data service from another one of the plurality of data service classes;
receive a job, the job implicating one or more data items associated with the source data service that are to be transferred to the destination data service; and
for each data item implicated by the job that requires a set of operations to be performed thereon in order to comply with requirements of the destination data service:
instantiate an operation pipeline based on the set of operations, the operation pipeline including one or more operators, each operator corresponding to a respective operation in the set of operations and being instantiated from one of the plurality of operator classes;
receive the data item via the first connector;
transform the data item to a transformed data item using the pipeline; and
transmit the transformed data item to the destination data service via the second connector.

13. The server of claim 12, wherein the set of operations are operations that transform the data item such that the transformed data item is compatible with the destination data service.

14. The server of claim 13, wherein each operator in the operation pipeline performs an operation on at least a portion of the data item.

15. The server of claim 12, wherein the transfer module is further configured to determine a sequence of the operations in the set of operations, the sequence of the operations defining an order by which the operators are to operate on the data item.

16. The server of claim 15, wherein the transfer module instantiates the operation pipeline by:
for each operation defined in the set of operations:
determining an operator that performs the defined operation;
instantiating the operator;
wherein input and output of each instantiated operator is based on the sequence of the operations.

17. The server of claim 12, wherein the data item is streamed from the source data service as a data stream comprised of a plurality of chunks, wherein the one or more operators operate on individual chunks of the data stream.

18. The server of claim 17, wherein the second connector streams the transformed data item to the destination data service.

19. The server of claim 18, wherein the job is one of a synchronization job, an archiving job, a publishing job, and a copying job.

20. The server of claim 19, wherein when the job is a synchronization job, the transfer module is further configured to:
determine destination data items to transfer from the destination data service to the source data service;
for each destination data item:
determine whether a set of operations needs to be performed on the destination data item to comply with requirements of the source data service;
when a set of operations needs to be performed on the destination data item:
instantiate an operation pipeline based on the set of operations, the operation pipeline including one or more operators, each operator corresponding to a respective operation in the set of operations;
receive the destination data item via the second connector;
transform the destination data item to a transformed destination data item using the operation pipeline; and
transmit the transformed destination data item to the source data service via the first connector.

21. The server of claim 12, wherein the transfer module instantiates a respective operation pipeline for each respective data item, the respective operation pipeline having operators for transforming the respective data item and only being used to transform the respective data item into a respective transformed data item.

22. A method for performing a search across a plurality of data services, the method comprising:
receiving, at a processing device, a search query;
for each data service of the plurality of data services:
instantiating, at the processing device, a search operator for the data service, each search operator being configured to convert the search query into a format accepted by the data service;
providing, at the processing device, the search query to each search operator to obtain a converted search query;
providing, at the processing device, the converted search query to the data service;
receiving, at the processing device, search results from the data service, the search results indicating data items stored at the data service that correspond to the converted search query; and
inserting, at the processing device, the search results into a virtual folder; and
providing, by the processing device, the virtual folder for display at a remote computing device.

23. The method of claim 22, further comprising, for each data service, instantiating, at the processing device, a connector for communicating with the data service, wherein the operator of the data service communicates the converted search query to the data service via the connector.

24. The method of claim 22, wherein the search results from each respective data service are inserted into the virtual folder.

25. The method of claim 23, wherein the virtual folder includes one or more subfolders.

26. The method of claim 22, further comprising:
receiving a job request based on the search results, the job request indicating a job implicating two or more of the plurality of data services; and
performing the job.
